(19) United States
(12) Patent Application Publication
(10) Pub. No.: US 2011/0264442 A1
(43) Pub. Date: Oct. 27, 2011

(54) VISUALLY EMPHASIZING PREDICTED KEYS OF VIRTUAL KEYBOARD

(75) Inventors: Weiyuan Huang, Beijing (CN); Lie Lu, Beijing (CN); Lijiang Fang, Bellevue, WA (US)

(73) Assignee: MICROSOFT CORPORATION, Redmond, WA (US)

(21) Appl. No.: 12/765,371

(22) Filed: Apr. 22, 2010

(51) Int. Cl. G06F 3/048; G06F 17/27; G06F 3/02

(52) U.S. Cl. 704/9; 345/168; 715/822; 715/773

(57) ABSTRACT

A computing system includes a touch display and a virtual keyboard visually presented by the touch display. The virtual keyboard includes a plurality of touch-selectable keys each having a visual appearance that dynamically changes. A touch-selectable key has a deemphasized visual appearance if the touch-selectable key is not predicted to be a next selected key, and the touch-selectable key has a prediction-emphasized visual appearance if the touch-selectable key is predicted to be a next selected key.

### BACKGROUND

Conventional keyboards enable users to enter text and other data by physically depressing mechanical keys. Some devices augment and/or replace conventional keyboards with virtual keyboards displayed on touch displays. Virtual keyboards enable users to enter text and other data by tapping virtual keys that are displayed by the touch display.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one embodiment of the disclosure, a computing system includes a virtual keyboard visually presented by a touch display. The virtual keyboard includes a plurality of touch-selectable keys. Each touch-selectable key has a visual appearance that dynamically changes such that a touch-selectable key has a deemphasized visual appearance if the touch-selectable key is not predicted to be a next selected key and the touch-selectable key has a prediction-emphasized visual appearance if the touch-selectable key is predicted to be a next selected key.

### BRIEF DESCRIPTION OF THE DRAWINGS

FIG. 1 shows an example computing system displaying a virtual keyboard in accordance with an embodiment of the present disclosure.

FIG. 2 shows a virtual keyboard in accordance with an embodiment of the present disclosure.

FIG. 3A shows another virtual keyboard in accordance with an embodiment of the present disclosure.

FIG. 3B schematically shows an example key of a virtual keyboard in accordance with an embodiment of the present disclosure.

FIG. 4 shows another virtual keyboard in accordance with an embodiment of the present disclosure.

FIG. 5 shows another virtual keyboard in accordance with an embodiment of the present disclosure.

FIG. 6 shows an example method of reducing tapping errors on a virtual keyboard including a plurality of keys.

FIG. 7 schematically shows a computing system in accordance with an embodiment of the present disclosure.

### DETAILED DESCRIPTION

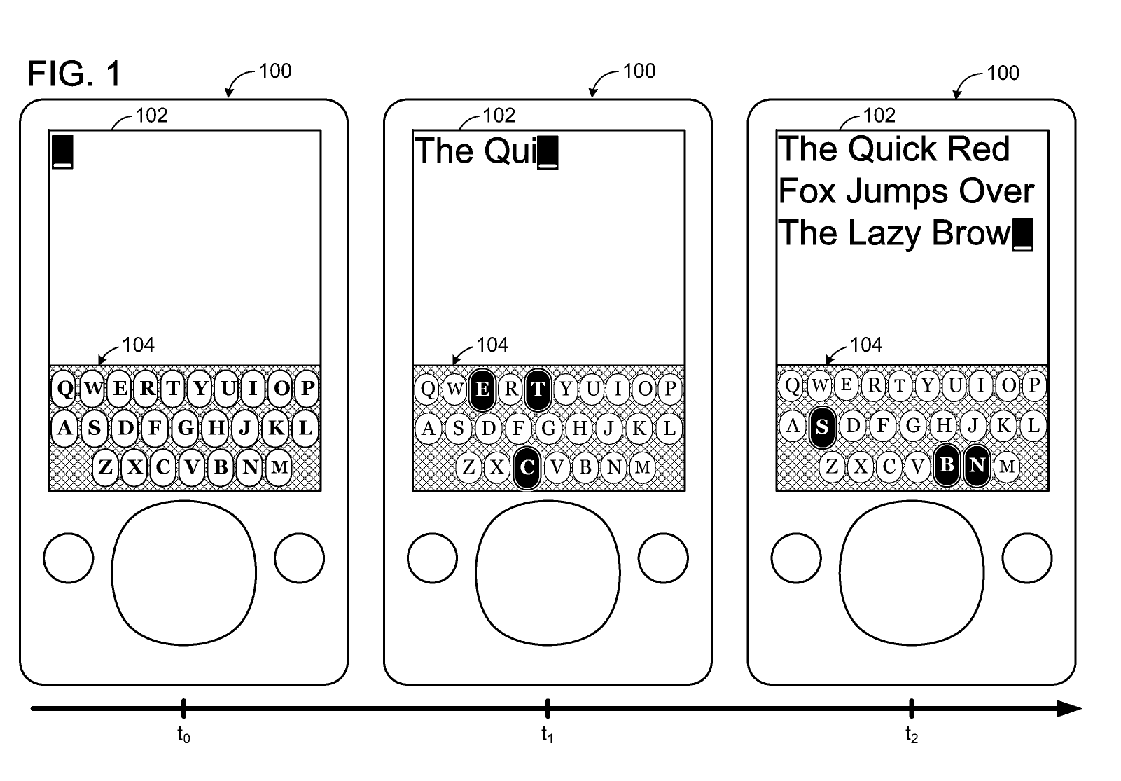

FIG. 1 shows a nonlimiting example of a computing system 100 including a touch display 102. Touch display 102 is configured to serve the dual function of a display and a user input device capable of recognizing touch input. For example, touch display 102 may visually present a virtual button that a user can see, and touch display 102 can detect when a user touches the virtual button. Virtually any type of touch display may be used without departing from the scope of this disclosure, including, but not limited to, capacitive touchscreens, resistive touchscreens, and optical-imaging touchscreens.

FIG. 1 further shows a virtual keyboard 104 visually presented by the touch display 102. Virtual keyboard 104 includes a plurality of touch-selectable keys. In the illustrated embodiment, virtual keyboard 104 is modeled after a conventional QWERTY keyboard, although virtually any arrangement of virtually any keys may be used (e.g., different keyboard layouts, different languages, etc.). Virtual keyboard 104 allows a user to enter textual input into computing system 100 without using a peripheral mechanical keyboard. Instead of pressing mechanical keys, a user “taps” the touch-selectable keys of the virtual keyboard 104.

Virtual keyboards can be presented in a variety of different sizes without departing from the scope of this disclosure. When used with a portable computing device, a virtual keyboard may have a relatively small size when compared to a conventional mechanical keyboard.

Furthermore, even when implemented on larger touch displays, virtual keyboards may not provide a user with the same type of tactile feedback provided by conventional mechanical keyboards. Small key size, the lack of tactile feedback, and/or other differences from mechanical keyboards may affect how effectively a user is able to quickly and accurately enter keyboard input on a virtual keyboard.

Despite the above described differences from conventional mechanical keyboards, virtual keyboard 104 is capable of providing an enjoyable, efficient, and powerful keyboarding experience. In fact, the dynamic nature of the touch display 102 allows the virtual keyboard 104 to provide a user with dynamically changing visual cues that are not provided by conventional mechanical keyboards. In other words, the visual appearance of the virtual buttons that a user is physically tapping can change in real-time. As explained below, a virtual keyboard in accordance with the present disclosure may dynamically change to improve the keyboarding experience of a user.

In particular, the virtual keyboard 104 may dynamically change appearances as a user types to provide the user with visual cues as to which keys are more likely to be tapped next. As explained in more detail below, computing system 100 may include a language model prediction module that is configured to predict one or more touch-selectable keys that are likely to be the key(s) a user wishes to tap next based on the key(s) the user has already tapped. Each touch-selectable key has a visual appearance that may dynamically change to provide this type of visual cue. Because the touch-selectable keys are the actual targets of the tap inputs, the changing visual appearances of the touch-selectable keys can help a user tap a desired portion of the touch display and thus enter a desired input.

A touch-selectable key may have a prediction-emphasized visual appearance if the touch-selectable key is predicted to be a next selected key, while the same touch-selectable key may have a deemphasized visual appearance if the touch-selectable key is not predicted to be a next selected key. As explained by way of example below, various different visual aspects of a touch-selectable key may be changed to emphasize and/or deemphasize a touch-selectable key without departing from the scope of this disclosure.

For example, at time t₁ of FIG. 1 a user has previously entered “The Qui.” The language model prediction module of the computing system predicts that the user is likely to next enter either “E,” “T,” or “C” (e.g., to spell “Quiet,” “Quit,” or “Quick”). As such, at time t₁, the E-key, the T-key, and the C-key are presented with a prediction-emphasized visual appearance, while all other keys are presented with a deemphasized visual appearance.

Continuing with this example, at time t₂ of FIG. 1 the user has previously entered “The Quick Red Fox Jumps Over the Lazy Brow.” The language model prediction module of the computing system predicts that the user is likely to next enter “S,” “B,” or “N.” As such, at time t₂, the S-key, the B-key, and the N-key are presented with a prediction-emphasized visual appearance, while all other keys are presented with a deemphasized visual appearance.

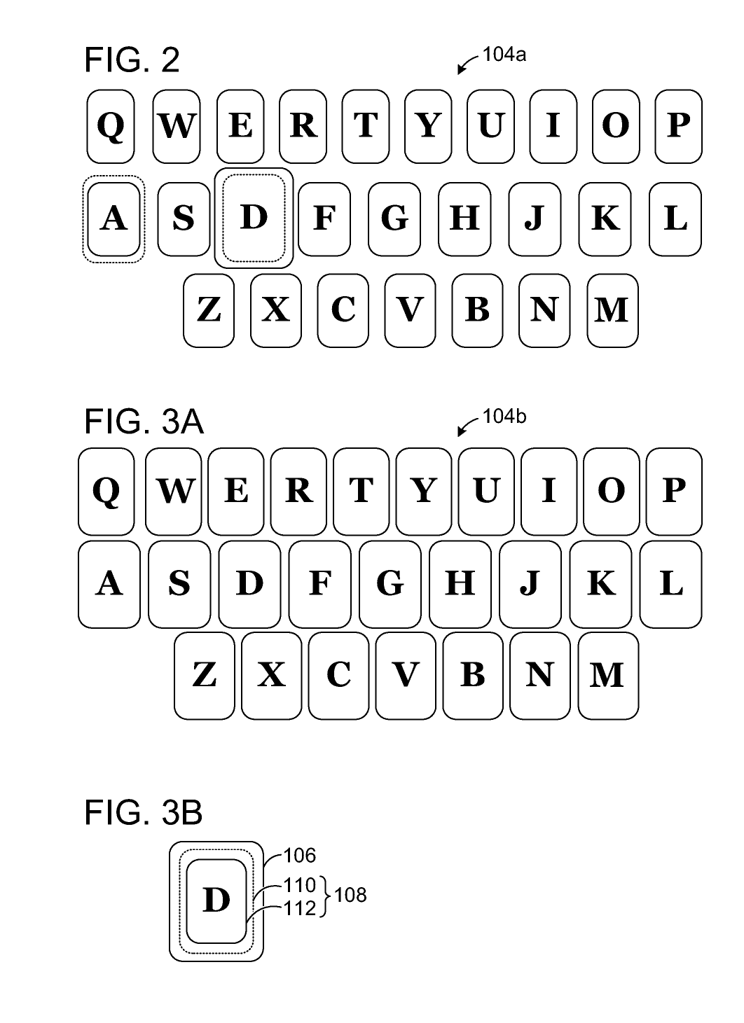

In some embodiments, a touch-selectable key has a physically smaller size when presented with the deemphasized visual appearance than when the same touch-selectable key is presented with the prediction-emphasized visual appearance. In other words, the keys that are predicted to be next selected keys are displayed larger than the keys that are not predicted to be next selected keys. For example, FIG. 2 shows a virtual keyboard 104a with a touch-selectable D-key that is larger than all other keys. In this example, the D-key is predicted to be the next selected key.

Furthermore, the area of the touch display from which a user tap is mapped to a particular touch-selectable key can be changed with the visual appearance of that touch-selectable key. In the example of FIG. 2, the area of the touch display which is associated with D-key input can be enlarged to coincide with the enlarged visual appearance of the D-key. As such, it will be physically easier for a user to tap the visual representation of the D-key and enter input associated with the D-key when the D-key is presented with the prediction-emphasized visual appearance and associated with the relatively larger touch-input display area.

All of the plurality of touch-selectable keys may be presented with a default visual appearance when no touch-selectable key is predicted to be a next selected key. For example, FIG. 3A shows a virtual keyboard 104b with all touch-selectable keys having a default visual appearance. In this example, none of the keys are predicted to be the next selected key.

The virtual keyboard 104b of FIG. 3A can be dynamically changed into the virtual keyboard 104a of FIG. 2 responsive to the D-key being predicted as the next selected key (e.g., responsive to a language model prediction module predicting the D-key as the next selected key). As an example, upon predicting the D-key to be the next selected key, the D-key may dynamically change to have a prediction-emphasized visual appearance (e.g., change from a default size to a larger size) and/or keys other than the D-key which are not predicted to be the next selected key may dynamically change to have a withdrawn visual appearance (e.g., change from a default size to a smaller size). In FIG. 2, dashed lines indicate a default size of the A-key and a default size of the D-key. In other words, the dashed line representation of the A-key and the dashed line representation of the D-key in FIG. 2 indicate the relative size of the corresponding keys in FIG. 3A. As can be seen, the D-key of virtual keyboard 104a is larger than the corresponding D-key of virtual keyboard 104b. On the other hand, the A-key of virtual keyboard 104a is smaller than the corresponding A-key of virtual keyboard 104b.

As shown by way of example in FIGS. 2 and 3, the deemphasized visual appearance may include a default visual appearance and a withdrawn visual appearance. In other words, the A-key of FIG. 2 and the A-key of FIG. 3A are both considered to have a deemphasized visual appearance—for example, the A-key of FIG. 2 has a withdrawn visual appearance, while the A-key of FIG. 3A has a default visual appearance. As a point of comparison, the D-key of FIG. 2 has a prediction-emphasized visual appearance, while the D-key of FIG. 3A has a default visual appearance.

This is further illustrated in FIG. 3B, where 106 indicates a prediction-emphasized visual appearance of an example D-key and 108 indicates a deemphasized visual appearance, which may be a default visual appearance 110 or a withdrawn appearance 112. In this example, prediction-emphasized visual appearance 106 is larger than default visual appearance 110, and withdrawn appearance 112 is smaller than the default visual appearance 110.

One or more of the plurality of touch-selectable keys may be presented with a withdrawn visual appearance when another of the plurality of touch-selectable keys is predicted to be a next selected key. In some embodiments, a touch-selectable key has a physically smaller size when presented with the withdrawn visual appearance than when the same touch-selectable key is presented with the default visual appearance.

In the example of FIG. 2, when the D-key is predicted to be the next selected key, all other keys are presented with the withdrawn visual appearance. In particular, while the D-key is enlarged from the default visual appearance of FIG. 3A to the prediction-emphasized visual appearance of FIG. 2, all other keys are shrunk from the default visual appearance of FIG. 3A to the withdrawn visual appearance of FIG. 2. In this example, all of the plurality of touch-selectable keys that are not predicted to be the next selected key are presented with the withdrawn visual appearance when the D-key is predicted to be the next selected key.

In other embodiments, some keys that are not predicted to be a next selected key may be presented with a withdrawn visual appearance, while other keys that are not predicted to be a next selected key are presented with a default visual appearance.

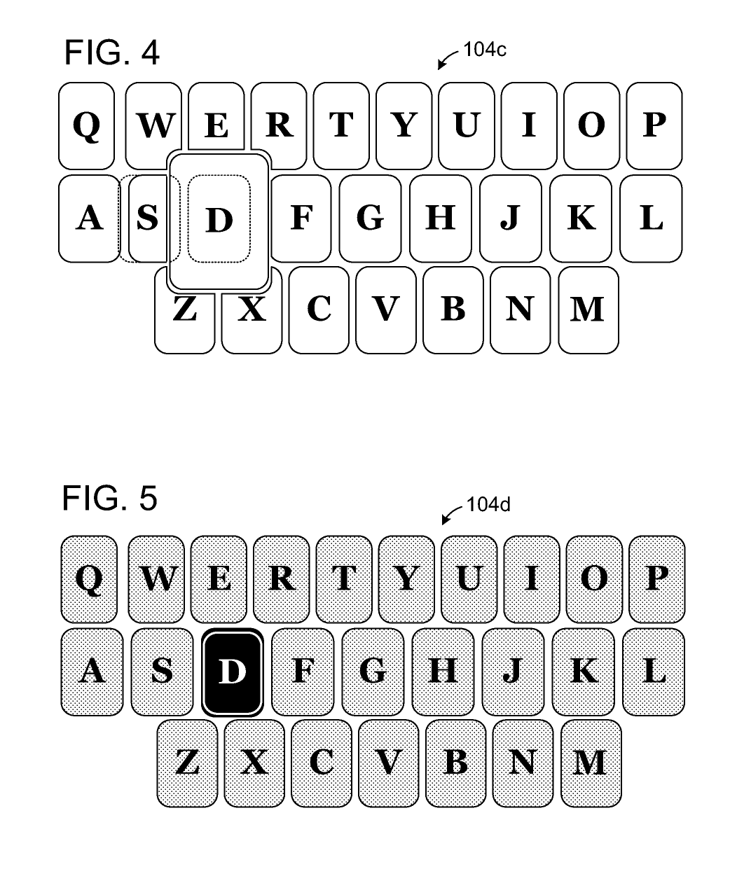

For example, FIG. 4 shows another virtual keyboard 104c in which the D-key is predicted to be the next selected key and has a prediction-emphasized visual appearance in the form of a key size that is larger than a corresponding default key size. In this example, touch-selectable keys that are not predicted to be a next selected key and that are adjacent to the D-key are presented with a withdrawn visual appearance (e.g., W-key, E-key, R-key, S-key, F-key, Z-key, and X-key). However, in this example, touch-selectable keys that are not predicted to be a next selected key and that are not adjacent to the D-key are presented with the default visual appearance (e.g., A-key).

In FIG. 4, dashed lines indicate a default size and position of the S-key and a default size and position of the D-key. In other words, the dashed line representation of the S-key and the dashed line representation of the D-key in FIG. 4 indicate the relative sizes and positions of the corresponding keys in FIG. 3A. As can be seen, the D-key of virtual keyboard 104c is larger than the corresponding D-key of virtual keyboard 104b. On the other hand, the S-key of virtual keyboard 104c is smaller than the corresponding S-key of virtual keyboard 104b. In this example, the size of the A-key, and other keys that are not adjacent to the D-key, does not change.

In the example of FIG. 4, the D-key occupies space that would otherwise be occupied by an adjacent touch-selectable key. For example, the prediction-emphasized version of the D-key in FIG. 4 occupies space that is occupied by the S-key of FIG. 3A when the S-key and the D-key have their default visual appearances. When the D-key is predicted to be the next selected key, the S-key vacates some of the space it usually occupies to make room for the prediction-emphasized version of the D-key. The W-key, E-key, R-key, F-key, Z-key, and X-key also vacate space to accommodate the prediction-emphasized version of the D-key. However, other keys, such as the A-key, do not change from their default appearances.

In the above examples, the relative size of a key is changed to visually indicate if that key is predicted to be a next selected key. In some embodiments, additional and/or alternative characteristics of a key may be dynamically changed to visually indicate that a key is predicted to be a next selected key.

For example, FIG. 5 shows a virtual keyboard 104d in which the D-key is predicted to be the next selected key. In this example, the D-key has a prediction-emphasized visual appearance in the form of a chromatic enhancement, which is schematically illustrated as solid shading in this example. In such embodiments, a touch-selectable key may be more chromatically muted with the deemphasized visual appearance than with the prediction-emphasized visual appearance. As a nonlimiting example, a key that is not predicted to be a next selected key (e.g., the A-key of FIG. 2) may be presented as a grey key, while a key that is predicted to be a next selected key (e.g., the D-key of FIG. 5) may be presented as a bright yellow key. It is to be understood that grey and yellow are provided as nonlimiting examples, and other color combinations may be used. Furthermore, while size and color are provided as two example methods of differentiating keys that are predicted to be next selected keys from keys that are not predicted to be next selected keys, virtually any other visually distinguishable characteristic may be used (e.g., flashing keys, vibrating keys, pulsing keys, brighter keys, etc.).

In some embodiments, a key may be presented with different colors, or other attributes, when the key is presented with a withdrawn visual appearance than when the same key is presented with a default visual appearance. As a nonlimiting example, a touch-selectable key may be more chromatically muted with the withdrawn visual appearance than with the default visual appearance. As a nonlimiting example, a key that is presented as a default key (e.g., the A-key of FIG. 3A) may be presented as a solid key, while a key that is presented as a withdrawn key (e.g., the A-key of FIG. 5) may be presented as a faded and/or partially transparent key. This is schematically shown in FIGS. 3 and 5. In the example of FIG. 5, the relative size of the keys does not change.

As another example, FIG. 1 shows a virtual keyboard 104 in which both the relative size and color of touch-selectable keys are dynamically changed to visually indicate which keys are predicted to be next selected keys. While only a few exemplary dynamic changes are illustrated and described herein, it is to be understood that various characteristics of the prediction-emphasized visual appearance, default visual appearance, and/or withdrawn visual appearance may be used to distinguish key(s) that are predicted to be next selected keys from key(s) that are not predicted to be next selected keys.

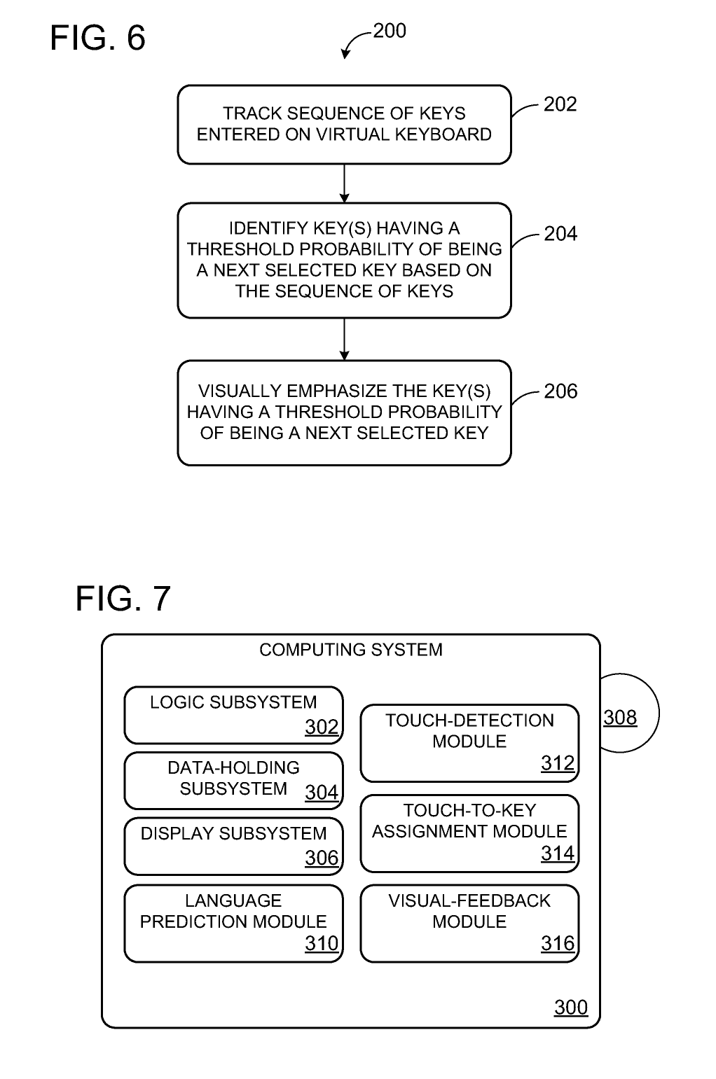

FIG. 6 shows an example method 200 of reducing tapping errors on a virtual keyboard including a plurality of keys. At 202, method 200 includes tracking a sequence of keys entered on the virtual keyboard. As explained below, a computing system may include a touch-detection module configured to recognize which of the plurality of keys presented by a touch display is being touched. Such a computing system may further include a touch-to-key assignment module configured to enter the key that is touched. The keys that are entered responsive to this type of user input can be tracked. As an example, when a user taps a key, the key may be appended into a cache unless the key is “space” or “enter”.

At 204, method 200 includes identifying one or more keys having a threshold probability of being a next selected key based on the sequence of keys that have been tracked. As an example, a language model prediction module may be used to determine the probability that a key will be the next key entered based on the currently cached key sequence. In some embodiments, the language model prediction module may analyze the sequence of keys using an N-Gram language model. The language model can be used to identify the probability that a particular key will be the next key entered. The key or keys that have a threshold probability of being chosen are then predicted to be the next key. This type of threshold probability may be an absolute threshold (e.g., greater than 70% chance of being selected), a relative threshold (e.g., three keys with highest probability of being selected, all keys at least 0.5 standard deviations above average probability of being selected, etc.), or a combination of an absolute threshold and a relative threshold (e.g., top three keys with at least a 70% chance of being selected).

At 206, method 200 includes visually emphasizing the one or more keys having a threshold probability of being a next selected key. As an example, FIGS. 1, 2, and 4 demonstrate visually emphasizing a key by enlarging the key. Furthermore, FIGS. 1, 2, and 4 demonstrate visually emphasizing a key by shrinking keys other than the key predicted to be the next key. In FIGS. 1 and 2, all keys other than the predicted key are shrunk. In FIG. 4, only keys adjacent to the predicted key are shrunk. As another example, FIG. 5 demonstrates visually emphasizing a key by chromatically enhancing the key and chromatically muting keys other than the predicted key.

In some embodiments, the above described methods and processes may be tied to a computing system. As an example, FIG. 7 schematically shows a computing system 300 that may perform one or more of the above described methods and processes. Computing system 100 of FIG. 1 is a nonlimiting example of computing system 300 of FIG. 7.

Computing system 300 includes a logic subsystem 302, a data-holding subsystem 304, and a touch display subsystem 306. Computing system 300 may optionally include components not shown in FIG. 7.

Logic subsystem 302 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 304 may include one or more physical, non-transitory, devices configured to hold data and/or instructions executable by the logic subsystem to implement the herein described methods and processes. When such methods and processes are implemented, the state of data-holding subsystem 304 may be transformed (e.g., to hold different data). Data-holding subsystem 304 may include removable media and/or built-in devices. Data-holding subsystem 304 may include optical memory devices, semiconductor memory devices, and/or magnetic memory devices, among others. Data-holding subsystem 304 may include devices with one or more of the following characteristics: volatile, nonvolatile, dynamic, static, read/write, read-only, random access, sequential access, location addressable, file addressable, and content addressable. In some embodiments, logic subsystem 302 and data-holding subsystem 304 may be integrated into one or more common devices, such as an application specific integrated circuit or a system on a chip.

FIG. 7 also shows an aspect of the data-holding subsystem in the form of computer-readable removable media 308, which may be used to store and/or transfer data and/or instructions executable to implement the herein described methods and processes.

The terms “module” and “engine” may be used to describe an aspect of computing system 300 that is implemented to perform one or more particular functions. In some cases, such a module or engine may be instantiated via logic subsystem 302 executing instructions held by data-holding subsystem 304. It is to be understood that different modules and/or engines may be instantiated from the same application, code block, object, routine, and/or function. Likewise, the same module and/or engine may be instantiated by different applications, code blocks, objects, routines, and/or functions in some cases.

Computing system 300 includes a language model prediction module 310 configured to predict one or more keys that are likely to be the next key tapped by a user. The language model prediction module may optionally use an N-Gram language model to identify one or more touch-selectable keys with a threshold probability of being a next selected key based on a sequence of previously entered keys.

Computing system 300 includes a touch-detection module 312 configured to recognize which of the plurality of touch-selectable keys is being touched by a user.

Computing system 300 includes a touch-to-key assignment module 314 configured to enter a touch-selectable key that is touched.

Computing system 300 includes a visual-feedback module 316 configured to visually indicate that a touch-selectable key is predicted to be a next selected key by updating the images presented by the touch display subsystem 306. As an example, the visual-feedback module may increase a size of a touch-selectable key relative to other touch-selectable keys and/or chromatically enhance a touch-selectable key relative to other touch-selectable keys.

Touch display subsystem 306 may be used to present a visual representation of data held by data-holding subsystem 304. As the herein described methods and processes change the data held by the data-holding subsystem, and thus transform the state of the data-holding subsystem, the state of touch display subsystem 306 may likewise be transformed to visually represent changes in the underlying data (e.g., change the size and/or color of a touch-selectable key). Touch display subsystem 306 may include one or more touch display devices utilizing virtually any type of technology. Such display devices may be combined with logic subsystem 302 and/or data-holding subsystem 304 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a touch display; and
a virtual keyboard visually presented by the touch display, the virtual keyboard including a plurality of touch-selectable keys each having a visual appearance that dynamically changes such that a touch-selectable key has a deemphasized visual appearance if the touch-selectable key is not predicted to be a next selected key and the touch-selectable key has a prediction-emphasized visual appearance if the touch-selectable key is predicted to be a next selected key.

2. The computing system of claim 1, where the touch-selectable key is smaller with the deemphasized visual appearance than with the prediction-emphasized visual appearance.

3. The computing system of claim 1, where the touch-selectable key is more chromatically muted with the deemphasized visual appearance than with the prediction-emphasized visual appearance.

4. The computing system of claim 1, where the deemphasized visual appearance includes a default visual appearance and a withdrawn visual appearance, where all of the plurality of touch-selectable keys are presented with the default visual appearance when no touch-selectable key is predicted to be a next selected key, and where one or more of the plurality of touch-selectable keys are presented with the withdrawn visual appearance when another of the plurality of touch-selectable keys is predicted to be a next selected key.

5. The computing system of claim 4, where the touch-selectable key is smaller with the withdrawn visual appearance than with the default visual appearance.

6. The computing system of claim 4, where the touch-selectable key is more chromatically muted with the withdrawn visual appearance than with the default visual appearance.

7. The computing system of claim 4, where all of the plurality of touch-selectable keys that are not predicted to be a next selected key are presented with the withdrawn visual appearance when one or more other of the plurality of touch-selectable keys are predicted to be a next selected key.

8. The computing system of claim 4, where touch-selectable keys that are not predicted to be a next selected key and are adjacent to a touch-selectable key that is predicted to be a next selected key are presented with the withdrawn visual appearance, while touch-selectable keys that are not predicted to be a next selected key and are not adjacent to a touch-selectable key that is predicted to be a next selected key are presented with the default visual appearance.

9. The computing system of claim 4, where a touch-selectable key that is predicted to be a next selected key occupies space that is otherwise occupied by an adjacent touch-selectable key with the default visual appearance but is vacated by the adjacent touch-selectable key with the withdrawn visual appearance.

10. The computing system of claim 1, further comprising a language model prediction module configured to predict one or more next selected keys.

11. The computing system of claim 10, where the language model prediction module uses an N-Gram language model to identify one or more touch-selectable keys with a threshold probability of being a next selected key based on a sequence of previously entered keys.

12. A method of reducing tapping errors on a virtual keyboard including a plurality of keys, the method comprising:
tracking a sequence of keys entered on the virtual keyboard;
identifying one or more keys having a threshold probability of being a next selected key based on the sequence of keys; and
visually emphasizing the one or more keys having a threshold probability of being a next selected key.

13. The method of claim 12, where identifying one or more keys having the threshold probability of being a next selected key includes analyzing the sequence of keys using an N-Gram language model.

14. The method of claim 12, where visually emphasizing the one or more keys includes enlarging the one or more keys.

15. The method of claim 12, where visually emphasizing the one or more keys includes shrinking keys other than the one or more keys.

16. The method of claim 15, where all keys other than the one or more keys are shrunk.

17. The method of claim 15, where only keys adjacent to the one or more keys are shrunk.

18. The method of claim 12, where visually emphasizing the one or more keys includes chromatically enhancing the one or more keys.

19. The method of claim 12, where visually emphasizing the one or more keys includes chromatically muting keys other than the one or more keys.

20. A computing system, comprising:
a touch display;
a virtual keyboard visually presented by the touch display, the virtual keyboard including a plurality of touch-selectable keys;
a touch-detection module configured to recognize which of the plurality of touch-selectable keys is being touched;
a touch-to-key assignment module configured to enter a touch-selectable key that is touched;
an N-Gram language model prediction module configured to predict one or more next selected keys based on a sequence of previously entered keys; and
a visual-feedback module configured to visually indicate that a touch-selectable key is predicted to be a next selected key by increasing a size of that touch-selectable key relative to other touch-selectable keys that are not predicted to be next selected keys and/or by chromatically enhancing that touch-selectable key relative to other touch-selectable keys that are not predicted to be next selected keys.
